(19) United States
(12) Patent Application Publication
(10) Pub. No.: US 2026/0097594 A1
(43) Pub. Date: Apr. 9, 2026

(54) WORK TABLE, INKJET PRINTING APPARATUS INCLUDING THE SAME AND METHOD OF MANUFACTURING THE SAME

(71) Applicant: SAMSUNG DISPLAY CO., LTD., YONGIN-SI (KR)

(72) Inventor: jungwoong byun, Yongin-si (KR)

(21) Appl. No.: 19/282,557

(22) Filed: Jul. 28, 2025

(30) Foreign Application Priority Data
Oct. 7, 2024 (KR) 10-2024-0136044

(51) Int. Cl. B41J 11/06; B41J 11/00; B41J 11/14

(52) U.S. Cl. CPC B41J 11/06; B41J 11/0085; B41J 11/14

(57) ABSTRACT

An inkjet printing apparatus includes a work table including a table body including a work region, a plurality of tile units arranged on the work region, a temperature control member disposed in at least one tile unit of the plurality of tile units, an inkjet assembly arranged on the tile unit and including a nozzle unit configured to drop ink from above the plurality of tile units, and a controller configured to individually control a temperature of the at least one tile unit by controlling current applied to the temperature control member.

### CROSS-REFERENCE TO RELATED APPLICATION

This application is based on and claims priority under 35 U.S. C. § 119 to Korean Patent Application No. 10-2024-0136044, filed on Oct. 7, 2024, in the Korean Intellectual Property Office, the disclosure of which is incorporated by reference herein in its entirety.

### BACKGROUND

### 1. Technical Field

The present disclosure relates to a work table, an inkjet printing apparatus including the same, and a method of manufacturing the same.

### 2. Discussion of Related Art

As the demand for display devices grows, display devices are becoming larger and thinner, and the need for high-precision inkjet processes for printing circuits or pixels of these display devices is also increasing.

### SUMMARY

The present disclosure provides an inkjet printing apparatus capable of performing a high-precision inkjet process and a method for manufacturing the same.

According to an aspect of the present disclosure, an inkjet printing apparatus includes a work table including a table body including a work region, a plurality of tile units arranged on the work region, a temperature control member disposed in at least one tile unit of the plurality of tile units, an inkjet assembly arranged on the tile unit and including a nozzle unit configured to drop ink from above the plurality of tile units, and a controller configured to individually control a temperature of the at least one tile unit by controlling current applied to the temperature control member.

The table body may include a mount hole formed to extend in a direction, and each tile unit of the plurality of tile units may include an engagement portion at least partially inserted into the mount hole.

The plurality of tile units may be arranged in a grid shape on the work region.

The at least one tile unit may include a base plate on which the temperature control member is arranged, and a top plate disposed opposite to the base plate.

The base plate may include a cable hole, wherein a cable connected to the temperature control member is disposed to pass through the cable hole.

A plurality of temperature control members, including the temperature control member, disposed in the plurality of tile units may be arranged spaced apart from each other on the base plate, and include a filler material disposed in a space between the plurality of temperature control members.

The base plate may have a higher heat conductivity than the top plate.

The temperature control member may include a Peltier element.

The controller may be further configured to individually control the temperature of the at least one tile unit based on a position at which the nozzle unit drops ink.

According to another aspect of the present disclosure, a work table of an inkjet printing apparatus, the work table may include a table body including a work region and including a plurality of through holes formed to extend in a direction, a plurality of tile units disposed on the work region, and a lift assembly including a plurality of pin modules disposed in the plurality of through holes.

The lift assembly may further include a frame formed to be movable in a direction parallel to an extension direction of the plurality of through holes and connected to the plurality of pin modules.

The pin module may include a lift tube movable, linearly, in the extension direction of the plurality of through holes and a bushing disposed around a circumference of the lift tube.

Each of the plurality of through holes may include a body pin hole extending along a portion of a movement path of the lift tube and a counter bore connected to the body pin hole and accommodating the bushing.

Each tile unit of the plurality of tile units may include a curved portion formed to curve inward from each vertex of the tile unit, wherein a tile pin hole may be formed by the curved portions of respective tile units of the plurality of tile units arranged adjacent to each other, and wherein at least a part of a pin module of the plurality of pin modules may be disposed in the tile pin hole.

Each pin module of the plurality of pin modules may include a pin tip arranged at an end portion disposed at a surface of each tile unit of the plurality of tile units.

Each pin module of the plurality of pin modules may be formed to be capable of securing a substrate supported on the pin tip by vacuum pressure.

According to another aspect of the present disclosure, a method of operating a work table of an inkjet printing apparatus includes preparing the work table comprising a table body, a lift assembly, and a plurality of tile units forming a surface of the work table, moving the lift assembly such that at least a part of a pin module of the lift assembly passes through a body pin hole formed in the table body, arranging a substrate on a pin tip of the pin module, moving the lift assembly such that the substrate contacts the surface of the work table, and securing the substrate to the work table by applying vacuum pressure to a surface of the substrate through the pin tip.

A method of operating a work table may further include controlling, individually, a temperature of the at least one tile unit of the plurality of tile units by controlling a current applied to a temperature control member the at least one tile unit.

A method of operating a work table may further include depositing an ink on the substrate, and individually control a temperature of each tile unit of the plurality of tile units by controlling a plurality of temperature control members of the plurality of tile units to match a temperature of the ink deposited on the substrate.

The securing the substrate to the work table by applying vacuum pressure may further include applying the vacuum pressure through a groove disposed in the pin tip to an air layer disposed between the plurality of tile units.

### BRIEF DESCRIPTION OF THE DRAWINGS

These and/or other features will become apparent and more readily appreciated from the following description of example embodiments, taken in conjunction with the accompanying drawings in which:

FIG. 1 is a perspective view schematically showing some components of an inkjet printing apparatus according to an embodiment of the present disclosure;

FIG. 2 is a front view schematically showing an inkjet printing apparatus according to an embodiment of the present disclosure;

FIG. 3 is a block diagram showing a configuration of an inkjet printing apparatus according to an embodiment of the present disclosure;

FIG. 4 is a block diagram showing a configuration of an inkjet printing apparatus according to another embodiment of the present disclosure;

FIG. 5 is a perspective view showing an example of a work table of FIG. 1;

FIG. 6 is a plan view showing an example of the work table of FIG. 1;

FIG. 7 is an enlarged view of a portion X of FIG. 6;

FIG. 8 shows a state in which a top plate is removed from FIG. 7;

FIG. 9 is a cross-sectional view of a portion cut along a line I-I′ of FIG. 7;

FIG. 10 is a cross-sectional view of a portion cut along a line II-II′ of FIG. 7;

FIG. 11 is a cross-sectional view of a portion cut along a line III-III′ of FIG. 7;

FIG. 12 is a perspective view showing an example of a tile unit of FIG. 5;

FIG. 13 is a view for describing an internal structure of a tile unit of FIG. 12;

FIG. 14 is a perspective view showing an example of a pin module of FIG. 2;

FIG. 15 is an enlarged view of a portion Y of FIG. 14;

FIG. 16 is a cross-sectional view for describing arrangement of a pin module;

FIG. 17 is a cross-sectional perspective view for describing arrangement of a pin module;

FIG. 18 is a flowchart for describing a method of manufacturing an inkjet printing apparatus according to an embodiment of the present disclosure;

FIG. 19 is a flowchart for describing an operation of preparing a tile unit of FIG. 18;

FIG. 20 is a view for describing an operation of arranging a tile unit; and

FIG. 21 is a flowchart for describing an operation of a work table of an inkjet printing apparatus according to an embodiment of the present disclosure.

### DETAILED DESCRIPTION

Hereinafter, embodiments of the present disclosure will be described in detail with reference to the accompanying drawings, and in description with reference to the drawings, the same or corresponding components are given the same reference numerals, and redundant description thereof may be omitted or simplified.

Aspects of the present disclosure may have various modifications thereto. Effects and features of the present disclosure, and methods for achieving them will become clear with reference to embodiments described herein in detail together with the drawings. However, the present disclosure is not limited to embodiments disclosed herein and may be implemented in various forms.

In the following disclosure, the terms such as first, second, etc., have been used to distinguish one component from other components, rather than limiting.

In the following disclosure, singular forms include plural forms unless apparently indicated otherwise contextually.

In the following disclosure, the terms “include”, “have”, or the like, are intended to mean that there are features, or components, described herein, but do not preclude the possibility of adding one or more other features or components.

In the following disclosure, when a portion, such as a film, a region, a component, etc., is present on or above another portion, this case may include not only a case where it is directly on the other portion, but also a case where another film, region, component, etc., is arranged between the portion and the other portion.

In the examples described herein, terms such as connect or combine do not necessarily imply a direct and/or fixed connection or combination of two members, unless the context clearly indicates otherwise, and do not exclude the presence of another member between the two members.

In the drawings, the size of components may be exaggerated or reduced for convenience of description. In some embodiments, the size and thickness of each component shown in the drawings may be arbitrarily shown for convenience of description, and the disclosure is not necessarily limited by the illustrations.

In a conventional inkjet printing process, a temperature change of a substrate due to a temperature of an ink may cause errors in the ink deposition, which may be due to a shifting or warping of the substrate. According to an aspect of the present disclosure, a substrate may have secured to a work table using a plurality of pin modules applying vacuum pressure evenly across a lower surface of the substrate. According to an aspect of the present disclosure, a thermal deformation of a substrate onto which a material (e.g., ink) is ejected may be reduced by locally controlling a temperature of a work table supporting the substrate. Aspects of the present disclosure may enable a high-precision inkjet process on the substrate.

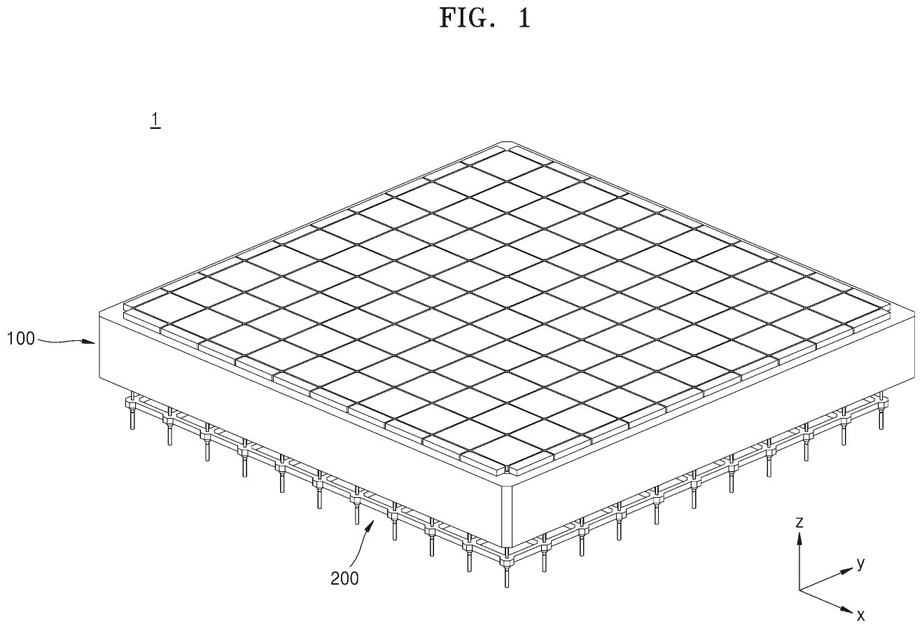

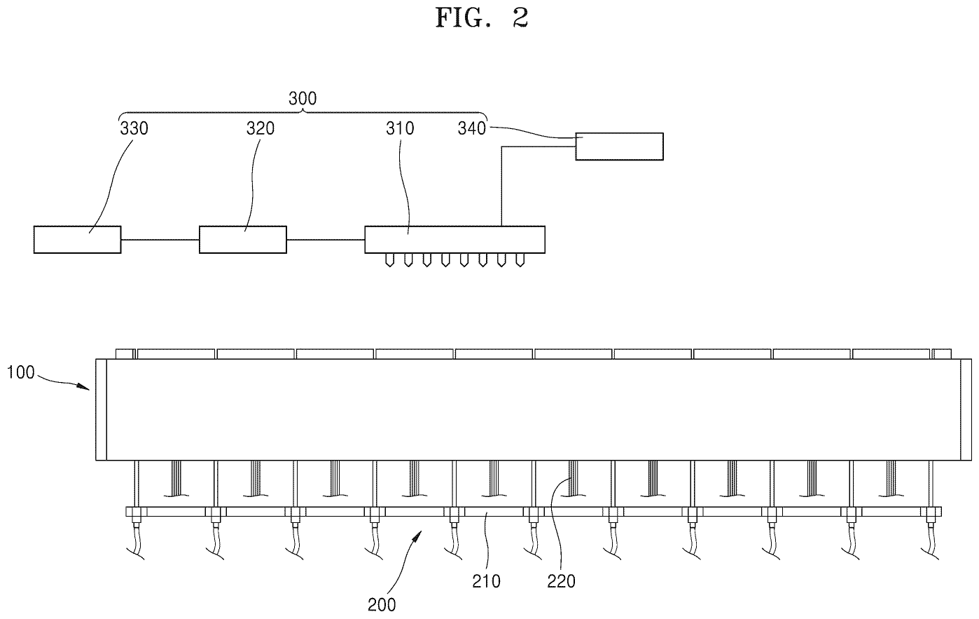

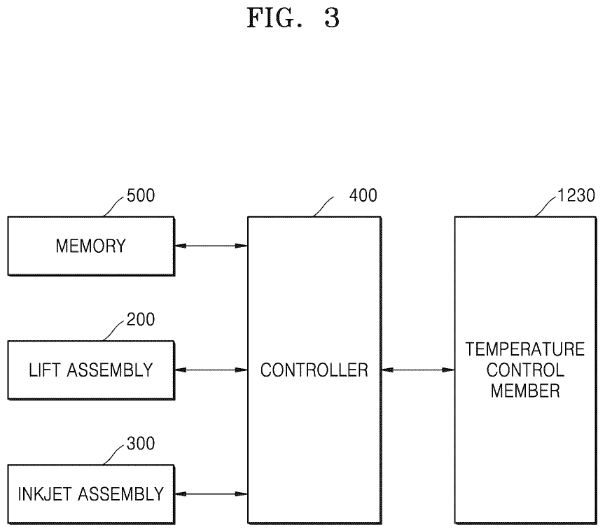

FIG. 1 is a perspective view schematically showing some components of an inkjet printing apparatus according to an embodiment of the present disclosure. FIG. 2 is a front view schematically showing an inkjet printing apparatus according to an embodiment of the present disclosure. FIG. 3 is a block diagram showing a configuration of an inkjet printing apparatus according to an embodiment of the present disclosure.

Referring to FIG. 1, FIG. 2, and FIG. 3, an inkjet printing apparatus 1 according to an embodiment of the present disclosure may include a work table 100, a lift assembly 200, and an inkjet assembly 300.

The work table 100 may support a substrate.

The work table 100 may include a surface configured to support the substrate on which an inkjet process may be performed.

The substrate may include any of a verity of materials. For example, the substrate may include a base substrate, a thin-film transistor, or an insulating layer. In some embodiments, the base substrate may be made of, but is not limited to, a glass material, a synthetic resin material, or a silicone material.

The substrate may be a unit substrate. Alternatively, the substrate may be a mother substrate, which may be divided into a plurality of unit substrates.

The substrate may be a single sheet of substrate. Alternatively, the substrate may be a plurality of laminated substrates.

The lift assembly 200 may move the substrate in a vertical direction (a Z-axis direction in FIG. 1). The lift assembly 200 may include a member may move in the up direction or the down direction (the Z-axis direction of FIG. 1), and through this member, the lift assembly 200 may move the substrate in the vertical direction.

The lift assembly 200 may support the substrate on the surface the work table 100. The lift assembly 200 may separate the substrate from the surface the work table 100 by moving the substrate in the vertical direction (the Z-axis direction in FIG. 1).

In an embodiment, the lift assembly 200 may include a frame 210 and a pin module 220.

The frame 210 may be arranged on a side of the work table 100. For example, the frame 210 may be arranged on a lower side of the work table 100. The frame 210 may move in a direction by a lift driving unit. In some embodiments, the frame 210 may move in the vertical direction (the Z-axis direction in FIG. 1) by the lift drive unit.

A plurality of pin modules 220 may be connected to the frame 210. The pin module 220 may move the substrate in the vertical direction (the Z-axis direction in FIG. 1).

In a case that the plurality of pin modules 220 are connected to the frame 210, the plurality of pin modules 220 may simultaneously move along with movement of the frame 210. Thus, the lift assembly 200 may stably support the substrate on the work table 100 without tilting or shifting, or stably separate the substrate from the work table 100 after completion of the inkjet process.

The inkjet assembly 300 may perform a function of ejecting ink onto the substrate supported by the work table 100.

The ink may be an inorganic material or an organic material for a display device to be formed by an inkjet printing process. Herein, the display device may be, but is not limited to, a light-emitting diode (LED) display or an organic LED (OLED) display. However, embodiments of the present disclosure are not limited to the manufacture of a display device, and the work table 100 of the inkjet printing apparatus 1 may be used for other applications.

In an embodiment, the inkjet assembly 300 may include at least one of a nozzle unit 310, an inkjet controller 320, a power supply unit 330, or an ink supply unit 340.

The nozzle unit 310 may be disposed above the work table 100.

The nozzle unit 310 may perform the inkjet process by dropping ink onto the substrate. The nozzle unit 310 may perform the inkjet process by dropping ink onto the substrate while moving in at least one direction.

The inkjet assembly 300 may further include an inkjet driving unit that moves the nozzle unit 310.

The nozzle unit 310 may perform the inkjet process while moving above the substrate by receiving power from the inkjet driving unit.

In an embodiment, the nozzle unit 310 may perform the inkjet process while moving back and forth above the substrate several times. In this case, the nozzle unit 310 may perform the inkjet process by dropping ink on the substrate over the course of multiple passes. In this way, the precision of a result printed on the substrate may increase.

In an embodiment, the nozzle unit 310 may include a plurality of nozzles. In this case, several nozzles may alternately drop ink droplets at specific locations on the substrate. Thus, the ink may be evenly deposited onto the substrate even when an ink ejection amount or detailed ejection performance differs from nozzle to nozzle.

The inkjet controller 320 may control various operations of the inkjet assembly 300. In some embodiments, the inkjet controller 320 may control one or more of a movement direction, the number of movements, an ink dropping amount, or an ink dropping time of the inkjet assembly 300.

The power supply unit 330 may supply power to one or more other components of the inkjet assembly 300. For example, the power supply unit 330 may supply power for driving to the nozzle unit 310 or the inkjet driving unit.

The ink supply unit 340 may store ink. In some embodiments, the ink supply unit 340 may be a tank or a cartridge that stores ink. The ink supply unit 340 may supply the stored ink to the nozzle unit 310 through a pipe or the like.

In an embodiment, the inkjet assembly 300 may further include an ink temperature controller, which may control the temperature of the ink. The ink temperature controller may be connected to the ink supply unit 340 or nozzle unit 310 to control the temperature of ink to be ejected onto the substrate.

Specifically, the inkjet controller 320 may control the temperature of the ink to be ejected. The inkjet controller 320 may control the temperature of the ink to control the viscosity of the ink. Accordingly, the spreadability of ink droplets dropped onto the substrate may be controlled.

The inkjet printing apparatus 1 according to an embodiment of the present disclosure may further include a temperature control member 1230, a controller 400, and a memory 500.

The temperature control member 1230 may be disposed on the work table 100. The temperature of the temperature control member 1230 may be changed using a current supplied from outside. As the temperature of the temperature control member 1230 changes, the temperature of at least one region of the work table 100 may be controlled.

The controller 400 may be connected to each component of the inkjet printing apparatus 1 to control the overall operation of the inkjet printing apparatus 1. In some embodiments, the controller 400 may include a plurality of components, or may be provided as a single component.

In some embodiments, the controller 400 may include the inkjet controller 320 to control an operation, performed by the inkjet assembly 300, of ejecting the ink. In addition, the controller 400 may be connected to the lift assembly 200 to control the movement of the lift assembly 200. The controller 400 may also be connected to the temperature control member 1230 and may control the temperature of at least one region of the work table 100 by controlling the temperature of the temperature control member 1230.

The memory 500 may store various pieces of information for the controller 400 to drive the inkjet printing apparatus 1. In some embodiments, the controller 400 may control the temperature of the ink, an ink ejection amount, the movement of the nozzle unit 310, etc., based on the information stored in the memory 500. Alternatively, the controller 400 may control the movement of the lift assembly 200 based on the information stored in the memory 500. Alternatively, the controller 400 may control the temperature of the temperature control member 1230 based on the information stored in the memory 500.

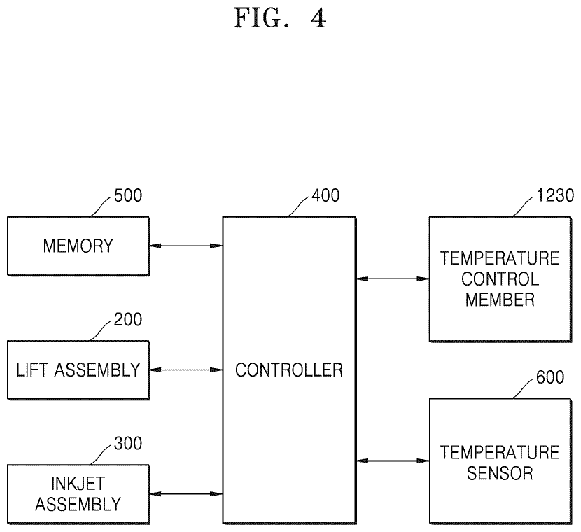

FIG. 4 is a block diagram showing a configuration of an inkjet printing apparatus according to another embodiment of the present disclosure.

Referring to FIG. 4, the inkjet printing apparatus 1 may further include a temperature sensor 600.

The temperature sensor 600 may measure at least one of the temperature of at least one region of the work table 100 or the temperature of the substrate onto which the ink is dropped.

In some embodiments, the temperature sensor 600 may be, but is not limited to, a thermal infrared camera, a thermal infrared vision sensor, a thermal infrared monitor, a thermal infrared scanner, etc.

In an embodiment, the temperature measured by the temperature sensor 600 may be visually displayed to a user through image processing as the temperature of at least one region of the work table 100 and the temperature of the substrate onto which the ink is dropped.

The controller 400 may control the temperature of the temperature control member 1230 based on the temperature of the work table 100 or the temperature of the substrate, measured through the temperature sensor 600. In some embodiments, when a region of the substrate has a higher temperature than another region, the controller 400 may control the temperature of the temperature control member 1230 to lower the temperature of a region of the work table 100 corresponding to the region of the substrate having the higher temperature. Alternatively, the controller 400 may prevent the temperature of the substrate from rapidly increasing due to the ink by previously lowering the temperature of the region of the work table 100 corresponding to the region of the substrate on which the ink is to be dropped.

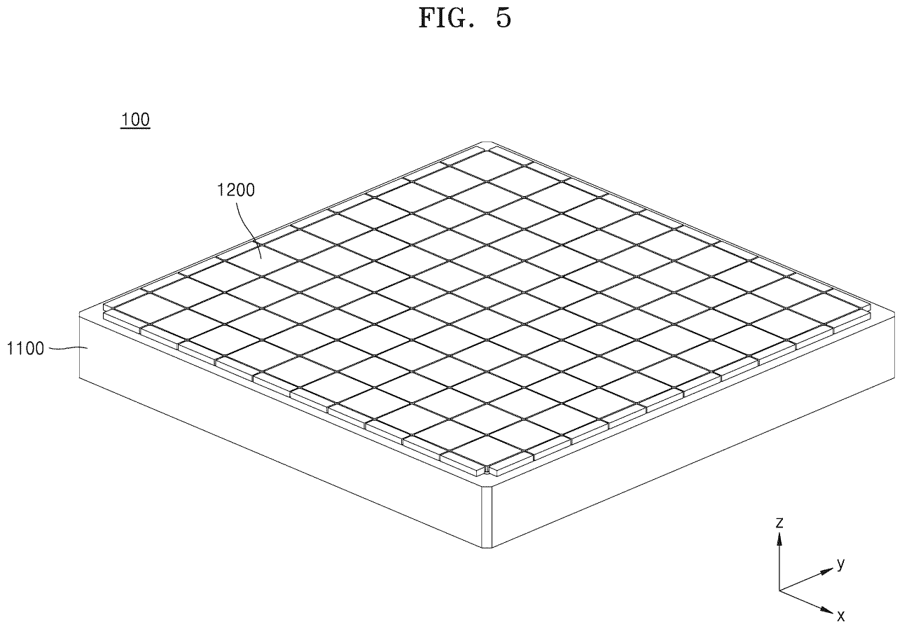

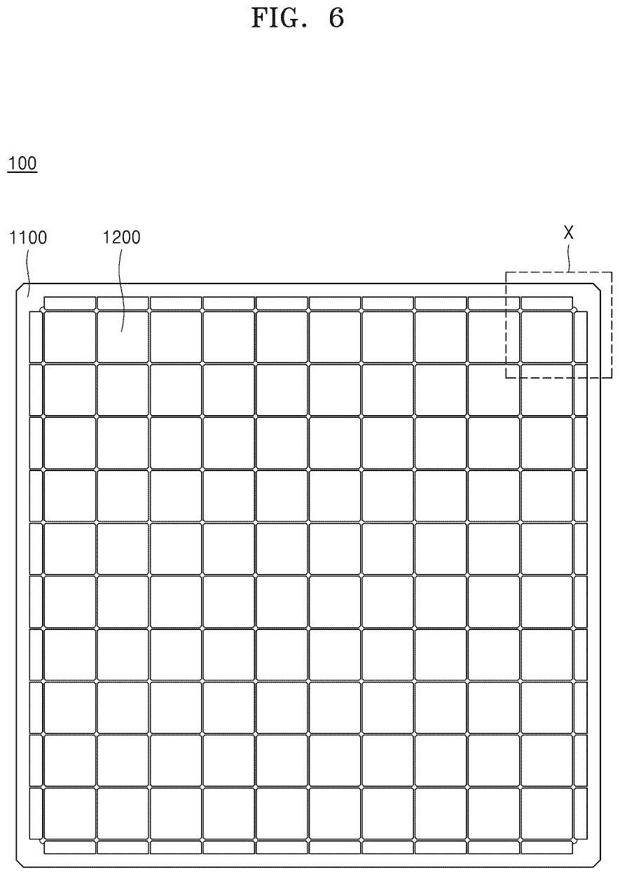

FIG. 5 is a perspective view showing an example of a work table of FIG. 1, and FIG. 6 is a plan view showing an example of the work table of FIG. 1.

Referring to FIG. 5 and FIG. 6, the work table 100 may include a table body 1100 and a tile unit 1200.

The table body 1100 may be configured such that the substrate may be supported thereon and the inkjet process may be performed on the substrate.

The table body 1100 may include a work region and a peripheral region surrounding the work region.

The work region may refer to a region on which the substrate is supported and the inkjet process is performed.

The substrate may be supported on the work region. In some embodiments, the substrate may be supported so as to overlap at least a part of the work region.

Herein, when the substrate is supported on the work region, it may mean that the substrate is arranged so as to contact the work region of the table body 1100, and also that at least one member or layer may be arranged between the substrate and the table body 1100. In some embodiments, as described below, the tile unit 1200 may be disposed on the table body 1100, and the substrate may be arranged on the tile unit 1200.

The table body 1100 may be made of a material having rigidity. In some embodiments, a top plate including the work region of the table body 1100 may be formed of a material having rigidity.

In an embodiment, the table body 1100 may be formed of a material having a large heat capacity. In a specific embodiment, the table body 1100 may include granite.

Accordingly, although the heat of the temperature control member 1230 disposed in the tile unit 1200 moves to the table body 1100, as described herein, the temperature change of the table body 1100 may not be large.

At least one tile unit 1200 may be disposed on the table body 1100. In some embodiments, a plurality of tile units 1200 having a size smaller than a top surface of the table body 1100 may be disposed on the table body 1100. The plurality of tile units 1200 may have a rectangular shape. However, aspects of the present disclosure are not limited thereto, and the plurality of tile units 1200 may be formed to have other shapes, such as a triangle shape.

The tile unit 1200 may be disposed on the work region of the table body 1100. However, the tile unit 1200 may be not only arranged on the work region, but may be arranged to cover the entire work region and may be arranged on a part of the peripheral region.

In an embodiment, the plurality of tile units 1200 may be arranged on the work region of the table body 1100, a work plane may be formed which corresponds to the work region of the table body 1100 and on which the substrate is supported and the inkjet process is performed.

In an embodiment, the tile unit 1200 may be arranged to have a pattern on the work region. In some embodiments, the tile unit 1200 may be formed to have a roughly quadrangular shape and may be arranged in a grid shape on the work region.

The plurality of tile units 1200 may be arranged to be in contact with each other and may be arranged to form a space between adjacent tile units 1200.

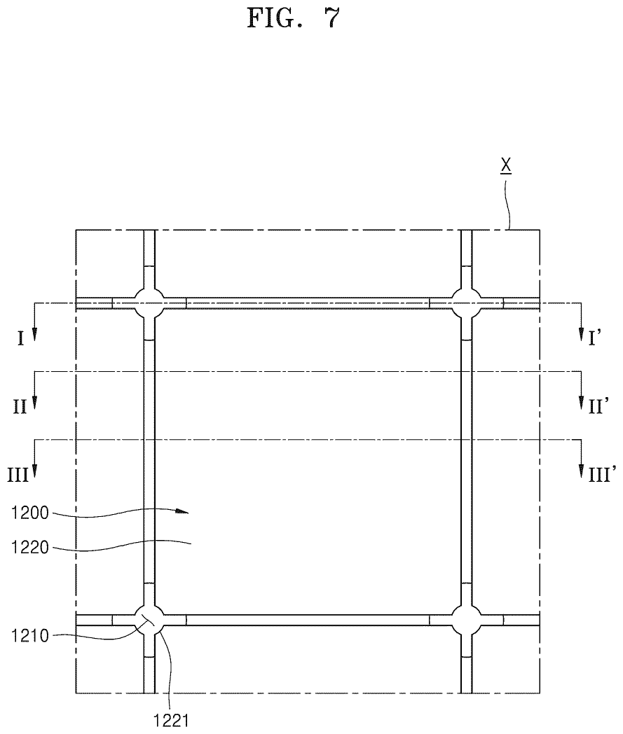

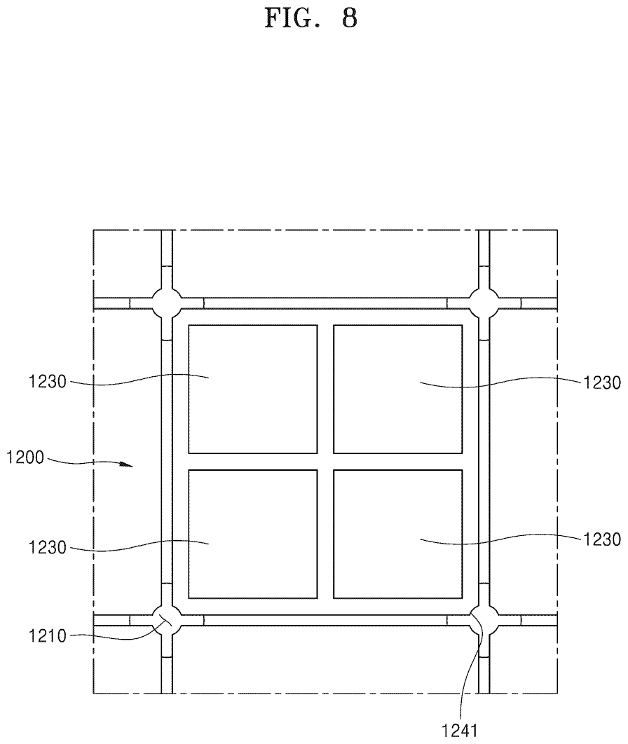

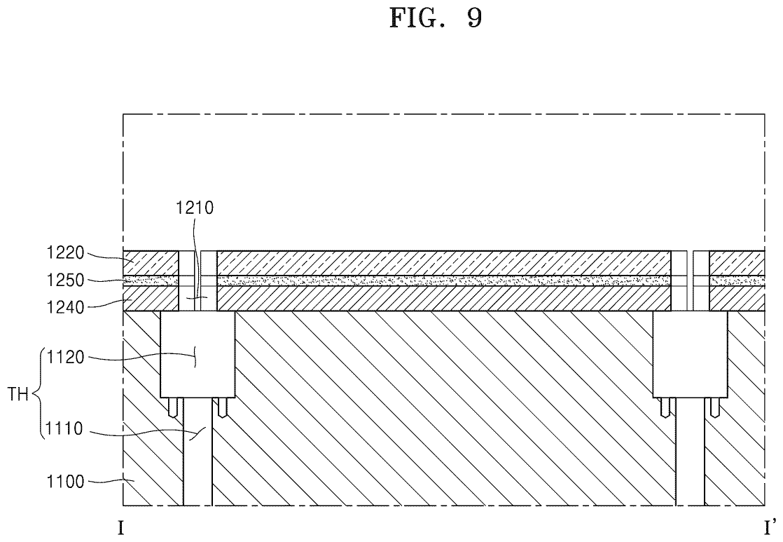

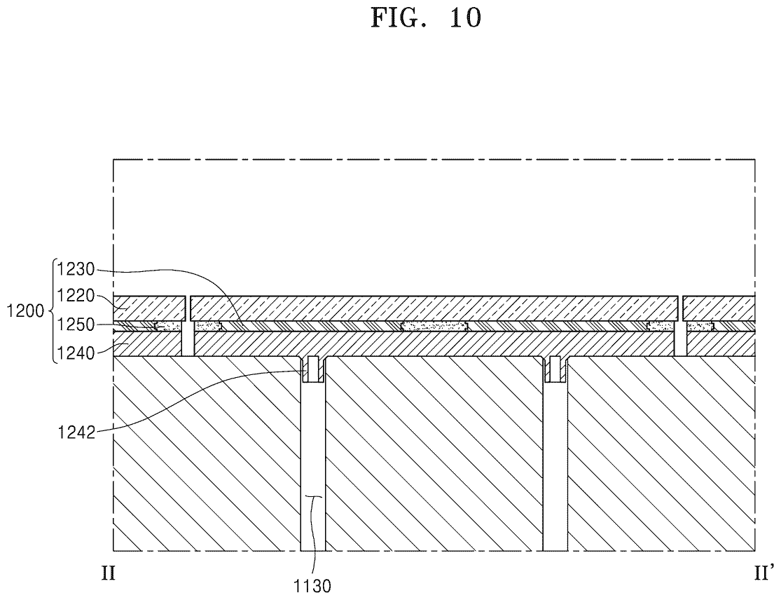

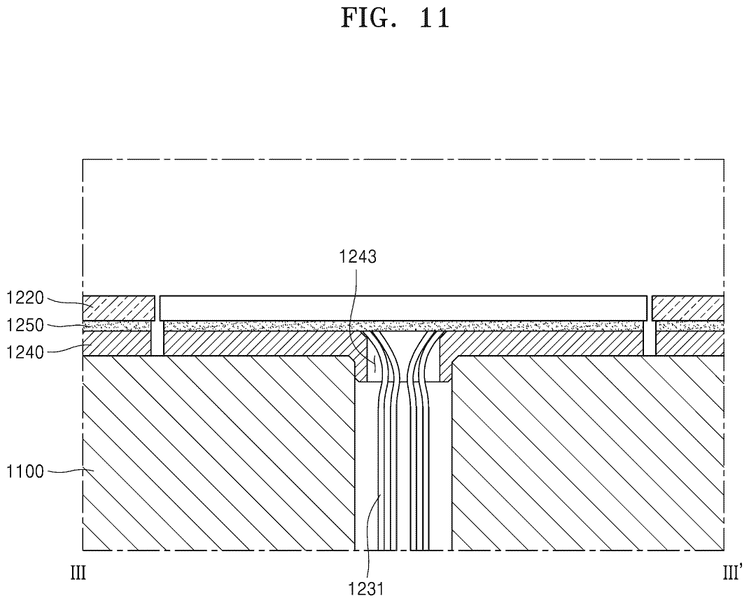

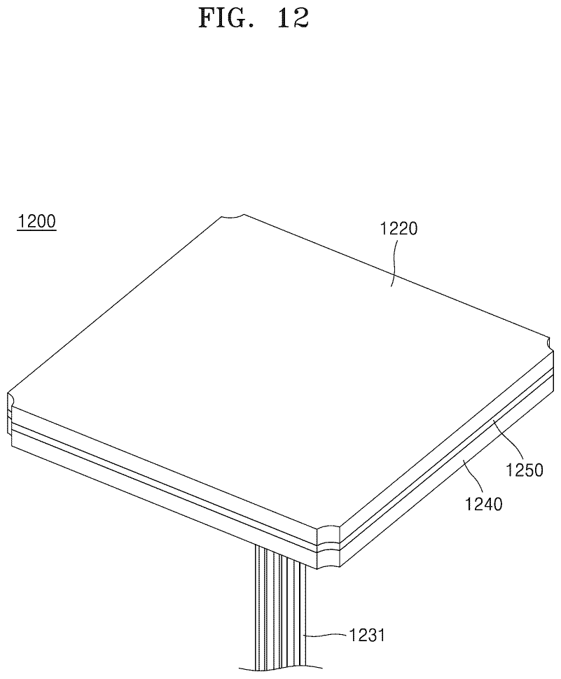

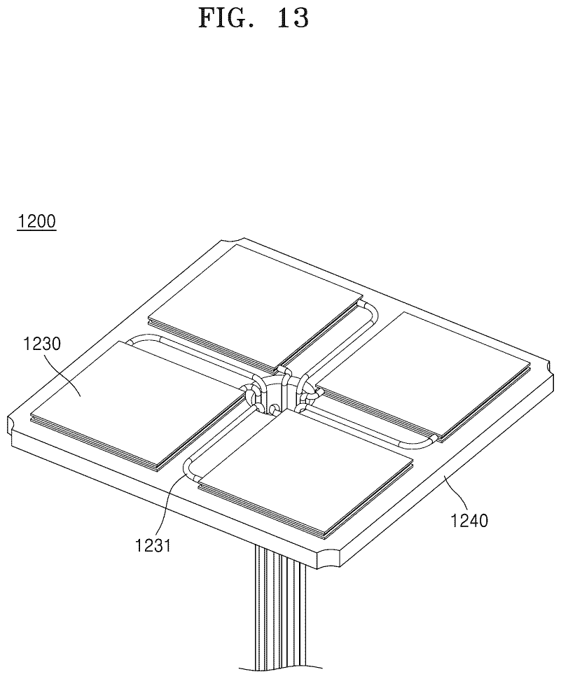

FIG. 7 is an enlarged view of a portion X of FIG. 6. FIG. 8 shows a state in which a top plate is removed from FIG. 7. FIG. 9 is a cross-sectional view of a portion cut along a line I-I′ of FIG. 7. FIG. 10 is a cross-sectional view of a portion cut along a line II-II′ of FIG. 7. FIG. 11 is a cross-sectional view of a portion cut along a line III-III′ of FIG. 7. FIG. 12 is a perspective view showing an example of a tile unit of FIG. 5. FIG. 13 is a view for describing an internal structure of a tile unit of FIG. 12.

Referring to FIGS. 7 to 13, the table body 1100 may include a through hole formed to extend in a direction.

The through hole may be formed in a height direction (the Z-axis direction in FIG. 5) to pass through the table body 1100.

A plurality of through holes may be provided.

At least a part of the lift assembly 200 may be arranged in the through hole TH as described herein. In some embodiments, each pin module 220 may be arranged in each through hole TH. At least a part of the pin module 220 may move in the height direction (the Z-axis direction in FIG. 5) of the table body 1100 in the through hole TH to support the substrate on the work table 100 or separate the substrate from the work table 100.

In an embodiment, the frame 210 of the lift assembly 200 may be formed to be movable in a direction parallel to the extension direction of the through hole TH (the Z-axis direction in FIG. 5). As the frame 210 moves in a direction parallel to the extension direction of the through hole TH (the Z-axis direction of FIG. 5), the plurality of pin modules 220 connected to the frame 210 may move simultaneously to stably support the substrate on the work table 100 or stably separate the substrate from the work table 100.

In an embodiment, the through hole TH may include two regions having different diameters. The through hole may include a body pin hole 1110 and a counter bore 1120.

The body pin hole 1110 may guide the movement path of at least some member of the pin module 220 as described herein. That is, at least some member of the pin module 220 may move the substrate in the vertical direction (the Z-axis direction in FIG. 5) while linearly moving along the body pin hole 1110.

The counter bore 1120 may be formed to have a greater diameter than the body pin hole 1110. In some embodiments, the counter bore 1120 may be connected to the body pin hole 1110 and may be formed in a shape with an expanded diameter compared to that of the body pin hole 1110. The counter bore 1120 may accommodate at least some member of the pin module 220, as described herein, which may improve the durability of the pin module 220 and the table body 1100.

The table body 1100 may further include a mount hole 1130 formed to extend in a direction. The mount hole 1130 may be formed in a height direction (the Z-axis direction in FIG. 5) to pass through the table body 1100.

The tile unit 1200 may include an engagement portion 1242 at least partially inserted into the mount hole 1130.

A separately provided coupling member may be disposed in the mount hole 1130 and may be engaged with the engagement portion 1242. After the tile unit 1200 is disposed on the table body 1100, the coupling member may be coupled to the engagement portion 1242 to couple the tile unit 1200 to the table body 1100.

In an embodiment, the coupling member may be inserted to pass through the mount hole 1130 from a lower side of the table body 1100 toward an upper side thereof and may be coupled to the engagement portion 1242.

In an embodiment, the coupling member may be, but is not limited to, a bolt.

In an embodiment, the coupling member may further include an elastic member that generates an elastic force in a longitudinal direction of the coupling member. In some embodiments, the elastic member may be a spring washer.

Thus, the coupling member may stably engage the tile unit 1200 to the table body 1100. For example, the coupling member may stably engage the tile unit 1200 to the table body 1100 without applying excessive stress to a tile after the tile unit 1200 is coupled to the table body 1100.

In an embodiment, a height control member may be further disposed between the tile unit 1200 and the table body 1100. In some embodiments, the height control member may be a shim member.

The height control member may control a flatness of a work plane formed by the plurality of tile units 1200.

Specifically, in a process of engaging the tile unit 1200 to the table body 1100 through the coupling member after the tile unit 1200 is disposed on a surface of the table body 1100, the height control member may be arranged under the tile unit 1200 that is lower in height or tilted compared to at least one other adjacent tile unit 1200 among the plurality of tile units 1200. Thus, the heights and inclination angles of individual tile units 1200 may be controlled by the height control member, and the flatness of the work plane formed by the plurality of tile units 1200 may be controlled.

In a process of controlling the flatness of the tile unit 1200 by the coupling member including the elastic member, excessive stress may not be applied to the tile unit 1200.

In an embodiment, the tile unit 1200 may include a top plate 1220, the temperature control member 1230, and a base plate 1240.

At least one temperature control member 1230 may be disposed on the base plate 1240. In a specific embodiment, a plurality of temperature control members 1230 may be arranged on the base plate 1240. The temperature control members 1230 may have a rectangular shape. However, aspects of the present disclosure are not limited thereto, and the temperature control members 1230 may be formed to have other shapes, such as a triangle shape.

The top plate 1220 may be disposed opposite to the base plate 1240. That is, the temperature control member 1230 may be disposed between the top plate 1220 and the base plate 1240 such that the tile unit 1200 may have a sandwich structure.

A tile pin hole 1210 may be formed in a region of tile units 1200 that are arranged adjacent to each other.

In an embodiment, the tile unit 1200 may be formed in a roughly quadrangular shape. The tile unit 1200 may include a curved portion formed to curve inward from each vertex.

In a specific embodiment, the top plate 1220 may be formed into a roughly quadrangular shape. The top plate 1220 may include a first curved portion 1221 formed to curve inward from each vertex. For example, the first curved portion 1221 may be formed to curve inward from adjacent vertices meeting at corners of the top plate 1220. In some embodiments, the first curved portion 1221 may have a cross-section in the shape of an arc.

The base plate 1240 may be formed in a shape corresponding to the top plate 1220. In some embodiments, the base plate 1240 may be formed in a quadrangular shape. The base plate 1240 may include a second curved portion 1241 formed to curve inward from each vertex. For example, the second curved portion 1241 may be formed to curve inward from adjacent vertices meeting at corners of the base plate 1240. In some embodiments, the second curved portion 1241 may have a cross-section in the shape of an arc.

The first curved portion 1221 and the second curved portion 1241 may be formed to correspond to each other. A plurality of temperature control members 1230 may be disposed on the base plate 1240, but may be disposed on an inner surface of the base plate 1240 so as not to extend beyond the base plate 1240.

Thus, the tile unit 1200 may have a shape in which a curved portion is formed at each vertex as a whole, as shown in FIG. 12.

As shown in FIG. 7 and FIG. 8, the plurality of tile units 1200 having curved portions formed therein may be arranged adjacent to each other. The tile pin hole 1210 may be formed by the curved portion formed in each tile unit 1200. In an embodiment, the curved portions formed in the respective tile units 1200 may together form a part of a circle.

The tile pin hole 1210 may be disposed at a position corresponding to the through hole TH in the table body 1100. In some embodiments, the tile pin hole 1210 and the through hole TH of the table body 1100 may communicate with each other. For example, the tile pin hole 1210 and the counter bore 1120 of the through hole TH may communicate with each other. In this way, the tile pin hole 1210, the counter bore 1120, and the body pin hole 1110 may form a continuous hole through the table body 1100 and the tile unit 1200.

Thus, as described herein, at least some component of the pin module 220 may move the substrate in the vertical direction (the Z-axis direction in FIG. 5) while moving along the body pin hole 1110, the counter bore 1120, and the body pin hole 1110.

The temperature of the temperature control member 1230 may be changed based on supplied current.

In an embodiment, the temperature control member 1230 may include a Peltier element.

The Peltier element may be a thermoelectric element that includes an n-type semiconductor and a p-type semiconductor and may perform heat absorption or heat dissipation depending on the direction of the current when the current is supplied.

The temperature control member 1230 may be connected to a cable 1231 separately provided to supply current from outside. However, aspects of the present disclosure are not limited thereto, and for example, the temperature control member 1230 may be connected to a pad disposed on the table body 1100 and electrically connected to separately supply current from outside.

In an embodiment, the base plate 1240 may include a cable hole 1243 through which the cable 1231 connected to the temperature control member 1230 may pass therethrough. The cable hole 1243 may be formed to pass through the base plate 1240.

The cable 1231 may extend in a direction from the temperature control member 1230 through the cable hole 1243, as shown in FIG. 13. Specifically, when the temperature control member 1230 is disposed on the base plate 1240, the cable 1231 may extend downward through the cable hole 1243 formed in the base plate 1240.

In an embodiment, the plurality of temperature control members 1230 may be arranged spaced apart from one another on the base plate 1240. In this case, the cable 1231 may be disposed in a space between the temperature control members 1230.

In an embodiment, a filler material 1250 may be further disposed in a space between the temperature control members 1230. In an embodiment, the filler material 1250 may include a resin filler.

Specifically, the filler material 1250 may be formed by filling at least a portion the space between the temperature control members 1230. When the cable 1231 is disposed in the space between the temperature control members 1230, the filler material 1250 may be filled to surround the cable 1231.

The filler material 1250 may protect the temperature control member 1230 and prevent or inhibit foreign substances from entering the temperature control member 1230. In addition, by selecting a variety of materials for the filler material 1250 as needed, heat may be transferred from the temperature control member 1230 to an adjacent direction or heat movement may be reduced. However, aspects of the present disclosure are not limited thereto, and the filler material 1250 may perform various functions.

In this way, the base plate 1240, the temperature control member 1230, the top plate 1220, and the filler material 1250 may form one body. Accordingly, each tile unit 1200 may be manufactured and individually installed on the table body 1100. However, aspects of the present disclosure are not limited thereto, and a plurality of tile units 1200 may be installed simultaneously on the table body 1100. For example, groups of tile units 1200 may be installed simultaneously on the table body 1100.

In an embodiment, the base plate 1240 may be formed of a material having a heat conductivity different than the top plate 1220. For example, the base plate 1240 may be formed of a material having a higher heat conductivity than the top plate 1220.

In an embodiment, the base plate 1240 may be formed of aluminum or may include aluminum or an aluminum alloy. In this way, heat exchange between the temperature control member 1230 and the table body 1100 may be quickly made, and a temperature gradient between the temperature control member 1230 and the table body 1100 may be reduced.

Specifically, when the temperature of the temperature control member 1230 increases, heat may move from the temperature control member 1230 to the table body 1100. In this case, as the table body 1100 may include a material having a large heat capacity, the heat transferred from the temperature control member 1230 may be absorbed into the table body 1100, but the temperature of the table body 1100 may not increase significantly. In addition, when the temperature of the temperature control member 1230 is lowered, heat from the table body 1100 may move in a direction toward the temperature control member 1230, and in this case, the temperature of the table body 1100 may not decrease significantly due to a large heat capacity thereof. For example, a significant change may be determined according to a stress applied to a substrate. More specifically, a significant change in temperature may be greater than about 0.5 degree Celsius (C), or greater than about 1 degree C., or greater than about 5 degrees C. To explain this feature from another perspective, the table body 1100 may serve as a heat sink, and the base plate 1240 may quickly perform heat exchange between the temperature control member 1230 and the table body 1100.

In an embodiment, the top plate 1220 may be formed of a material including synthetic resin having a lower heat conductivity than the base plate 1240. In an embodiment, the top plate 1220 may include a polyether ether ketone (PEEK) material. In this way, as the heat is transferred from the temperature control member 1230 to the tile unit 1200, additional heat exchange between the tile units 1200 arranged adjacent to each other may be reduced. For example, individual temperature control of the tile units 1200 may be improved.

In another example, the top plate 1220 may include alumina.

In an embodiment, the table body 1100 may further include a component for dissipating accumulated heat to outside. In some embodiments, the table body 1100 may further include a cooling module.

Hereinbelow, a function, performed by the temperature control member 1230, of controlling the temperature of the table body 1100 is described.

The controller 400 may individually control the temperature of the tile units 1200. In some embodiments, the controller 400 may control the temperature of each tile unit 1200 by individually controlling the temperature of the temperature control member 1230 of each tile unit 1200.

In an embodiment, the controller 400 may individually control the temperature of the tile unit 1200 based on a position at which the nozzle unit 310 drops (e.g., ejects) the ink onto the substrate.

In an embodiment, when the nozzle unit 310 drops the ink onto the substrate, the temperature of the substrate may rise due to the ink, such that the controller 400 may reduce the temperature of the temperature control member 1230 corresponding to the position at which the ink is dropped. In an embodiment, the controller 400 may control the temperature control member 1230 based on the temperature of the substrate or work table 100, measured by the temperature sensor 600.

In another example, the controller 400 may reduce the temperature of the temperature control member 1230 corresponding to the position at which the nozzle unit 310 is to drop the ink. That is, when ink having a higher temperature than the substrate is dropped, the temperature of the substrate may not increase rapidly due to the ink by reducing the temperature of the temperature control member 1230 disposed at the position before the ink is dropped.

In another example, to increase the temperature of the ink dropped onto the substrate, the controller 400 may increase the temperature of the temperature control member 1230 corresponding to the position at which the ink is dropped or is to be dropped.

In an embodiment, the controller 400 may control the amount of current to be supplied to the temperature control member 1230 based on a target temperature of the temperature control member 1230. In some embodiments, the controller 400 may measure the temperature of a specific temperature control member of the temperature control members 1230 or a tile unit of the tile units 1200 where the temperature control member 1230 is positioned, through the temperature sensor 600, and may calculate the amount of heat required for each position based on a difference from the target temperature. The controller 400 may calculate the amount of current to be supplied to the temperature control member 1230 disposed at a specific position based on the calculated amount of heat, and may control the temperature of the temperature control member 1230 based on the calculated amount of current.

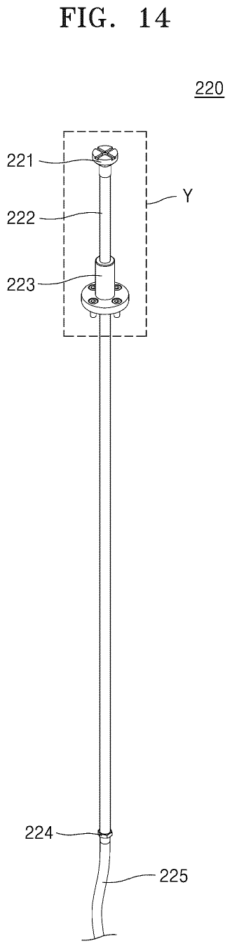

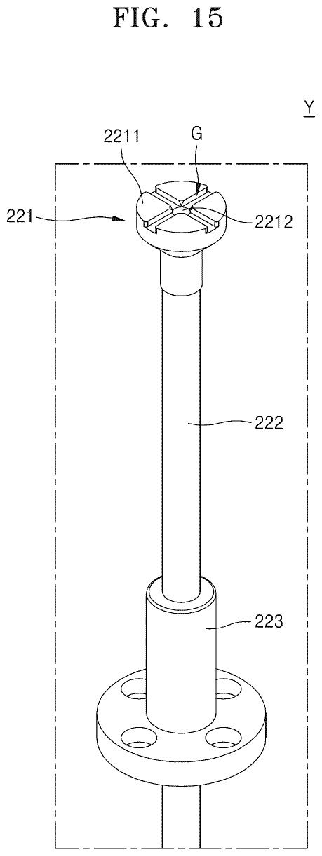

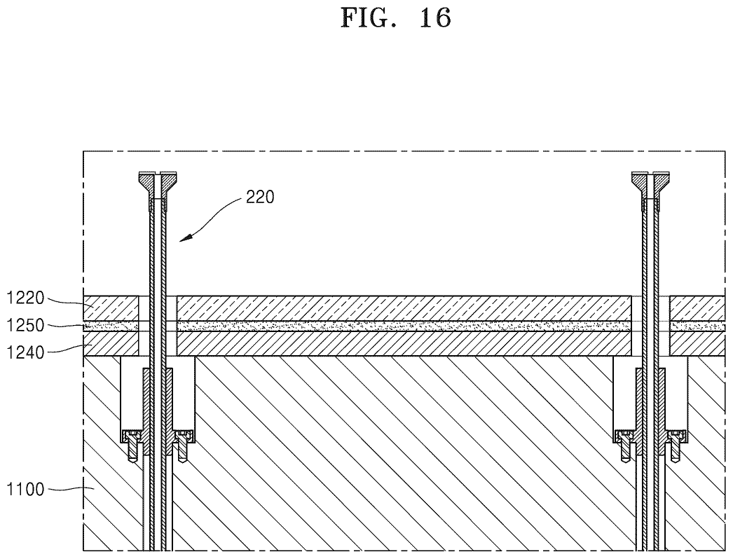

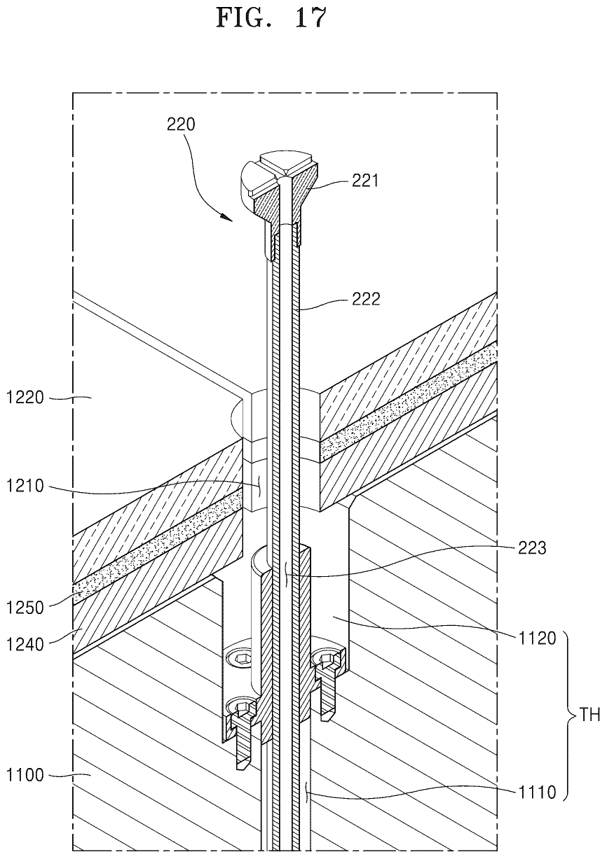

FIG. 14 is a perspective view showing an example of a pin module of FIG. 2. FIG. 15 is an enlarged view of a portion Y of FIG. 14. FIG. 16 is a cross-sectional view for describing arrangement of a pin module. FIG. 17 is a cross-sectional perspective view for describing arrangement of a pin module.

Referring to FIGS. 14 to 17, the lift assembly 200 may include the plurality of pin modules 220.

As described herein, the plurality of pin modules 220 may be connected to the frame 210. Thus, as the frame 210 moves, the plurality of pin modules 220 connected to the frame 210 may move simultaneously.

The pin module 220 may include a pin tip 221, a lift tube 222, and a bushing 223. The pin tip 221 may be configured to contact with the substrate. The lift tube 222 may be moveable, linearly, in a direction (the Z-axis direction in FIG. 5).

The pin tip 221 may be disposed at an end portion of the pin module 220 to support the substrate. In some embodiments, the pin tip 221 may be a member that lifts the substrate in contact with the substrate.

In an embodiment, the pin tip 221 may include an extension portion 2211 and a suction hole 2212.

The extension portion 2211 may be formed on a side of the pin tip 221. The extension portion 2211 may be formed in a shape extending outward from the central axis of the pin tip 221. In some embodiments, the extension portion 2211 may be formed to extend outward from the central axis of the pin tip 221 to have an area greater than the lift tube 222.

A surface of the extension portion 2211 may come into contact with the substrate. That is, the extension portion 2211 may support the substrate by coming into contact with the substrate through the movement of the lift tube 222.

In an embodiment, the extension portion 2211 may be formed roughly in the shape of a circle. In this case, an area of the extension portion 2211 may be less than or equal to an area of the tile pin hole 1210.

When the lift tube 222 moves in a direction toward the table body 1100, the pin tip 221 may move together, and the extension portion 2211 may be inserted into the tile pin hole 1210. Further, the lift tube 222 connected to the frame 210 may linearly move relative to the bushing 223, which may be secured to the table body 1100. For example, the lift tube 222 may slide through the bushing 223.

In an embodiment, the lift tube 222 may move downward until the extension portion 2211 is disposed on the same plane as the tile pin hole 1210. In some embodiments, when the substrate is supported on the extension portion 2211, the lift tube 222 may move in a direction toward a lower side of the table body 1100 such that the extension portion 2211 and the tile unit 1200 may form the same plane. In this case, the substrate may be supported more stably by the extension portion 2211 and the tile unit 1200.

In an embodiment, the pin tip 221 may include a material having relatively low heat conductivity, being capable of precision machining, and having a relatively low coefficient of friction. In some embodiments, the pin tip 221 may include PEEK material. Thus, even when the pin tip 221 contacts the substrate, damage to the substrate may be minimized.

The lift tube 222 may move linearly in a direction parallel to the extension direction of the through hole TH of the table body 1100 (the Z-axis direction in FIG. 5).

In an embodiment, the lift tube 222 may be formed of a material having rigidity. Thus, the substrate may be stably supported when the lift tube 222 is lifted or lowered to move the substrate.

The lift tube 222 may be arranged to pass through the body pin hole 1110 and the tile pin hole 1210. Thus, the lift tube 222 may move to pass through the body pin hole 1110 and the tile pin hole 1210. That is, the body pin hole 1110 and the tile pin hole 1210 may guide the movement path of the lift tube 222.

In an embodiment, the pin module 220 may further include the bushing 223 formed to cover the circumference of the lift tube 222. For example, the bushing 223 may be disposed around a circumference of the lift tube 222. In some embodiments, the bushing 223 may be formed in a shape including a cylindrical shape that covers the circumference of the lift tube 222 to overlap with a region of the lift tube 222. The bushing 223 may be seal around the lift tube 222 to reduce or prevent a vacuum pressure from leaking through the through hole TH. The bushing 223 may be disposed in the counter bore 1120 and seal around a base of the counter bore 1120 to reduce or prevent a vacuum pressure from leaking through the through hole TH.

The bushing 223 may be disposed in the counter bore 1120. In some embodiments, the bushing 223 may be formed in a shape that extends along at least a portion of the counter bore 1120. The bushing 223 may have a height that is less than a height of the counter bore 1120. The bushing 223 may be fixed to the counter bore 1120, and the lift tube 222 may move linearly through the bushing 223 while being inserted into the bushing 223.

Specifically, as the lift tube 222 may move while passing through a space between the table body 1100 and the tile unit 1200 as described herein, the lift tube 222 may cause friction with the table body 1100 or the tile unit 1200 when the movement direction of the lift tube 222 is tilted. Therefore, the bushing 223 may accurately guide the movement path of the lift tube 222. The bushing 223 may also prevent or reduce friction between the lift tube 222 and the table body 1100 or the lift tube 222 and the tile unit 1200 by covering the lift tube 222.

In an embodiment, the pin module 220 may be formed to secure the substrate supported on the pin tip 221.

In a specific embodiment, the suction hole 2212 may be formed through the pin tip 221 in the longitudinal direction of the pin tip 221. A through hole communicating with the suction hole 2212 may be formed in the lift tube 222 in the longitudinal direction of the lift tube 222. The pin tip 221 may be disposed at a first end portion of the lift tube 222 as described herein, and a nipple member 224 may be disposed at a second end portion of the lift tube 222. The nipple member 224 may connect the lift tube 222 to a suction tube 225. The suction tube 225 may be connected to a separately provided pump, etc.

When the substrate is supported on the work table 100 by the pin module 220, the substrate may be secured onto the pin module 220 by a pump or the like applying vacuum pressure. In some embodiments, the pump or the like may suck air through the suction tube 225, the lift tube 222, and the suction hole 2212, and the substrate may be secured onto the pin tip 221 by the vacuum pressure.

In an embodiment, at least one groove G formed in the area direction may be formed in the extension portion 2211 of the pin tip 221. In an embodiment, the groove G may be formed in the shape of a cross groove in the extension portion 2211 of the pin tip 221.

Thus, a leak may occur at the pin tip 221 during a securing operation, and an air layer formed between the tile units 1200 may be depressurized to generate the vacuum pressure in the air layer. Accordingly, the pin module 220 may evenly secure the substrate by the vacuum pressure applied over the entire lower area of the substrate.

Hereinafter, a method of manufacturing the inkjet printing apparatus 1 according to another aspect of the present disclosure will be described.

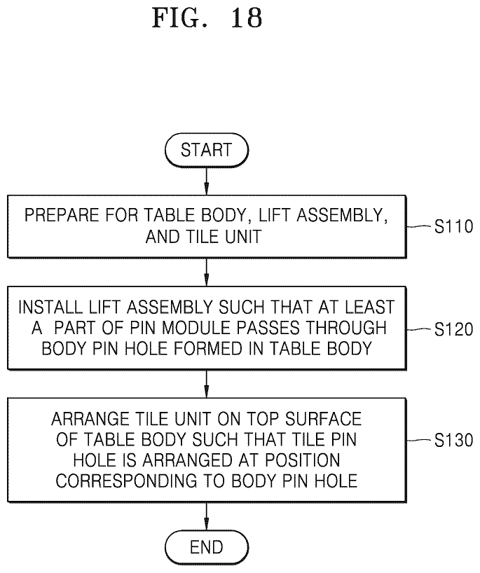

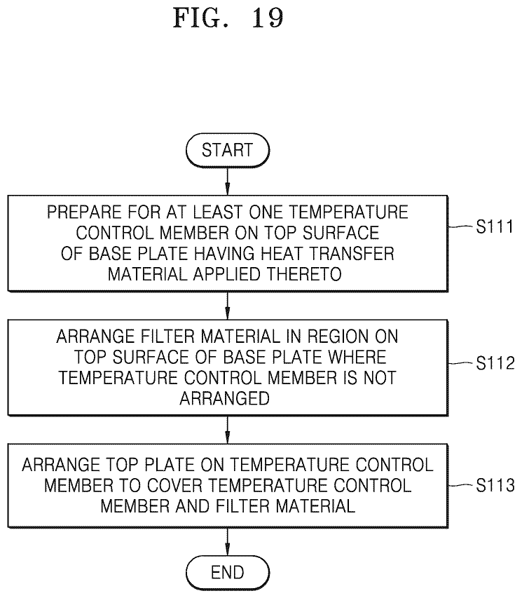

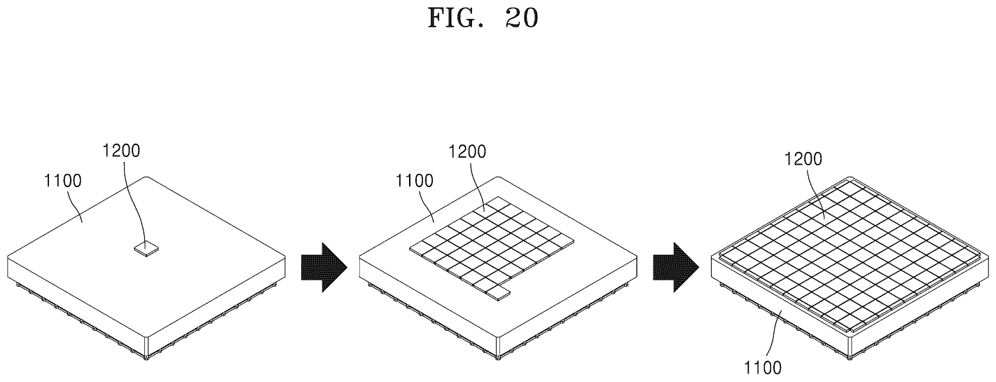

FIG. 18 is a flowchart for describing a method of manufacturing an inkjet printing apparatus according to an embodiment of the present disclosure, FIG. 19 is a flowchart for describing an operation of preparing a tile unit of FIG. 18, and FIG. 20 is a view for describing an operation of arranging a tile unit.

Referring to FIG. 18, a method of manufacturing the inkjet printing apparatus 1 according to an embodiment of the present disclosure may include operation S110 of preparing the table body 1100, the lift assembly 200, and the tile unit 1200, operation S120 of installing the lift assembly 200 such that at least a part of the pin module 220 of the lift assembly 200 passes through the body pin hole 1110 formed in the table body 1100, and operation S130 of arranging the tile unit 1200 on a top surface of the table body 1100 such that the tile pin hole 1210 formed between the tile units 1200 is disposed at a position corresponding to the body pin hole 1110.

Operation S110 of preparing the table body 1100, the lift assembly 200, and the tile unit 1200 may be an operation of preparing each of the table body 1100, the lift assembly 200, and the tile unit 1200 described with reference to FIGS. 1 to 17.

An operation of preparing the table body 1100, an operation of preparing the lift assembly 200, and an operation of preparing the tile unit 1200 may be performed regardless of the order. In some embodiments, the respective operations may be performed simultaneously or according to the order.

Operation S120 of installing the lift assembly 200 may be an operation of installing the lift assembly 200 on the table body 1100.

In operation S120 of installing the lift assembly 200, the bushing 223 may be disposed in the counter bore 1120 of the table body 1100. The lift tube 222 may be arranged to pass through the body pin hole 1110 and the bushing 223. In this case, the bushing 223 may be disposed first in the counter bore 1120 and then the lift tube 222 may be arranged to pass through the body pin hole 1110 and the bushing 223, and the lift tube 222 may be first inserted into the bushing 223 and then the lift tube 222 and the bushing 223 may be inserted into the table body 1100 and installed.

As described herein, as the plurality of body pin holes 1110 may be formed in the table body 1100, the plurality of pin modules 220 may be disposed in each body pin hole 1110.

The bushing 223 may be fixedly coupled to the table body 1100 by a separately provided coupling member after being disposed in the counter bore 1120. In some embodiments, the coupling member may be, but is not limited to, a screw, a bolt, a pin, etc.

Operation S130 of arranging the tile unit 1200 may be an operation of arranging the tile unit 1200 in the work region of the table body 1100.

Operation S130 of arranging the tile unit 1200 may be an operation of arranging a tile in the work region on a top surface of the table body 1100 such that the tile pin hole 1210 is disposed at a position corresponding to the body pin hole 1110. Specifically, the tile unit 1200 in which the curved portion is formed may be arranged such that the curved portion overlaps a part of an outer circumferential surface of the body pin hole 1110. In this way, as the plurality of tile units 1200 may be arranged adjacent to each other along the outer circumferential surface of the body pin hole 1110, the tile pin hole 1210 may be formed at a position corresponding to the body pin hole 1110.

Operation S130 of arranging the tile unit 1200 may include an operation of arranging the tile unit 1200 on the top surface of the table body 1100 and then coupling the coupling member and the engagement portion 1242 of the tile unit 1200 through the mount hole 1130 formed in the table body 1100.

In an embodiment, the coupling member may be disposed on the tile unit 1200 such that the engagement portion 1242 is inserted into the mount hole 1130, and then may be inserted into the mount hole 1130 from the lower side of the table body 1100 toward the upper side thereof and thus may be coupled to the engagement portion 1242.

In an embodiment, operation S130 of arranging the tile units 1200 may further include an operation of controlling the height of each tile unit 1200.

The operation of controlling the height of each tile unit 1200 may be an operation of controlling the height of each tile unit 1200 such that the tile units 1200 form a horizontal plane.

The operation of controlling the height of each tile unit 1200 may include an operation of arranging the tile unit 1200 on the table body 1100 and then arranging the height control member between the tile unit 1200 and the main body. That is, the height control member may be disposed under the tile unit 1200 that is lower in height or tilted compared to other adjacent tile units 1200 among the plurality of tile units 1200.

In an embodiment, an operation of coupling the coupling member to the engagement portion 1242 of the tile unit 1200 and an operation of controlling the height of the tile unit 1200 may be performed simultaneously. That is, the coupling member may be coupled to the engagement portion 1242 while controlling the height of the tile unit 1200.

In an embodiment, referring to FIG. 20, operation S130 of arranging a plurality of tile units 1200 may be an operation of arranging the tile units 1200 from the inside of the table body 1100 toward the outside.

Specifically, the tile units 1200 may be disposed from the inside of the work region of the table body 1100 toward the outside thereof. That is, the tile units 1200 may be first disposed at a position adjacent to the center of the work region of the table body 1100 and sequentially disposed toward the outside from the center. The flatness of the tile units 1200 may be easily controlled during the process of arranging the tile units 1200, and the arrangement of the tile units 1200 may be easily performed. However, aspects of the present disclosure are not limited thereto, and the operation S130 of arranging the plurality of tile units 1200 may be performed any of a verity of ways. For example, the tile units 1200 may be arranged using a scanning method from a corner of the table body 1100 and in successive rows.

Referring to FIG. 19, the operation of preparing the tile unit 1200 may include operation S111 of arranging at least one temperature control member 1230 on the top surface of the base plate 1240 to which a heat transfer material is applied, operation S112 of arranging the filler material 1250 in a region of the top surface of the base plate 1240 where the temperature control member 1230 is not arranged, and operation S113 of arranging the top plate 1220 on the temperature control member 1230 to cover the temperature control member 1230 and the filler material 1250.

Operation S111 of arranging at least one temperature control member 1230 on the top surface of the base plate 1240 may include an operation of applying the heat transfer material to a region of the base plate 1240.

In an embodiment, the heat transfer material may be thermal grease.

At least one temperature control member 1230 may be arranged at a position where the heat transfer material is applied.

In an embodiment, the heat transfer material may be applied to a plurality of regions of the base plate 1240, and the plurality of temperature control members 1230 may be disposed at those positions.

In this way, the heat transfer material may be disposed between the base plate 1240 and the temperature control member 1230.

The heat transfer material may transfer heat between the base plate 1240 and the temperature control member 1230. Thus, heat may easily move from a relatively high-temperature region, such as, the temperature control member 1230 or the base plate 1240 to the top plate 1220 on an opposite side of the tile unit 1200.

Operation S112 of arranging the filler material 1250 may be an operation of arranging the filler material 1250 in a region on the top surface of the base plate 1240 where the temperature control member 1230 is not arranged. In some embodiments, the filler material 1250 may be formed by filling at least a portion of the space between the temperature control members 1230.

When the cable 1231 is disposed in the space between the temperature control members 1230, the filler material 1250 may be filled to surround the cable 1231.

Operation S113 of arranging the top plate 1220 may be an operation of arranging the top plate 1220 on the temperature control member 1230 to cover the temperature control member 1230 and the filler material 1250 after the temperature control member 1230 and the filler material 1250 are disposed on the base plate 1240.

Operation S113 of arranging the top plate 1220 may include an operation of applying the heat transfer material onto the temperature control member 1230.

In an embodiment, the heat transfer material may be thermal grease.

Thereby, the heat transfer material may be disposed between the temperature control member 1230 and the top plate 1220.

The heat transfer material may transfer the heat between the temperature control member 1230 and the top plate 1220. Thus, heat may easily move from a high-temperature one of the temperature control member 1230 and the top plate 1220 to the opposite side.

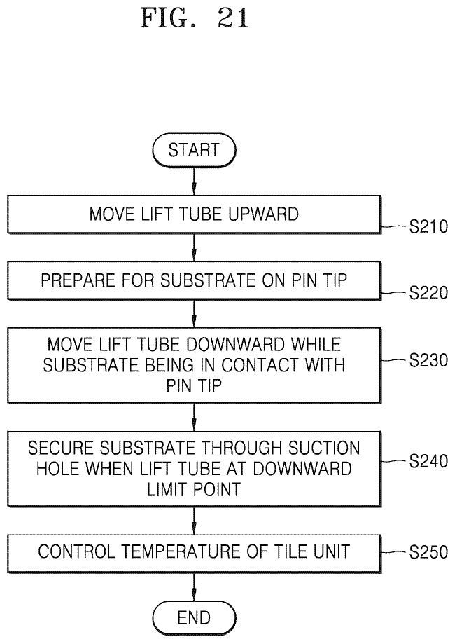

FIG. 21 is a flowchart for describing an operation of a work table of an inkjet printing apparatus according to an embodiment of the present disclosure. The operation of work table of the inkjet printing apparatus may include an operation of the lift assembly.

Referring to FIG. 21, an operating method of the work table 100 of an inkjet printing apparatus 1 according to an embodiment of the present disclosure may include operation S210 of moving the lift tube 222 upward, operation S220 of arranging the substrate on the pin tip 221, operation S230 of moving the lift tube 222 downward while the substrate being in contact with the pin tip 221, operation S240 of securing the substrate through the suction tube 225 when the lift tube 222 moves downward to a limit point, and operation S250 of controlling a temperature of a tile unit.

Operation S210 of moving the lift tube 222 upward may be an operation of arranging the substrate on the work table 100. The lift tube 222 may move to the upper side of the work table 100 such that the substrate may be arranged.

The lift tube 222 may move linearly along the body pin hole 1110 and the tile pin hole 1210 while passing through the inside of the bushing 223, as described herein.

The plurality of lift tubes 222 may be connected to the frame 210 of the lift assembly 200. Accordingly, as the frame 210 moves to the upper side of the work table 100, the plurality of lift tubes 222 connected to the frame 210 may linearly move simultaneously. Further, the plurality of lift tubes 222 connected to the frame 210 may linearly move relative to the bushings 223, which may be secured to the table body 1100. For example, the plurality of lift tubes 222 may slide through the bushings 223.

Operation S220 of arranging the substrate on the pin tip 221 may be an operation of arranging the substrate on the work table 100.

Specifically, operation S220 of arranging the substrate on the pin tip 221 may be an operation of arranging the substrate on the pin tips 221 of the plurality of pin modules 220. The substrate may come into contact with the extension portion 2211 of the pin tip 221.

Operation S230 of moving the lift tube 222 downward while the substrate is in contact with the pin tip 221 may be an operation of moving the substrate disposed on the pin tip 221 downward and seating the substrate on the work table 100, such that the substrate may be supported by the work table 100.

The lift tube 222 may move linearly along the body pin hole 1110 and the tile pin hole 1210 while passing through the inside of the bushing 223, as described herein.

The plurality of lift tubes 222 may be connected to the frame 210 of the lift assembly 200. Accordingly, as the frame 210 moves to the lower side of the work table 100, the plurality of lift tubes 222 connected to the frame 210 may linearly move simultaneously.

Operation S240 of securing the substrate through the suction tube 225 when the lift tube 222 moves downward to the limit point may be an operation of securing the substrate when the lift tube 222 moves downward to the limit point and coupling the substrate to the work table 100.

In an embodiment, the limit point to which the lift tube 222 moves downward may be a point at which the extension portion 2211 forms the same plane as the tile unit 1200. The point at which the extension portion 2211 forms the same plane as the tile unit 1200 may be a limit point.

When the lift tube 222 moves to the limit point, a pump or the like may secure the substrate through the suction tube 225 and vacuum pressure. In some embodiments, the pump or the like may suck air through the suction tube 225, the lift tube 222, and the suction hole 2212, thereby allowing the substrate to be secured onto the pin tip 221 by the vacuum pressure.

In an embodiment, at least one groove G formed in the area direction may be formed in the extension portion 2211 of the pin tip 221. In an embodiment, the groove G may be formed in the shape of a cross groove in the extension portion 2211 of the pin tip 221.

Thus, in operation S240 of securing the substrate through the suction tube 225, a leak may occur at the pin tip 221, and the air layer formed between the tile units 1200 may be depressurized to generate a vacuum pressure in the air layer. Accordingly, the substrate may be evenly-secured by the vacuum pressure over the entire lower area thereof.

In this way, the inkjet printing apparatus 1 according to an embodiment of the present disclosure may prevent or reduce partial thermal expansion of the substrate that occurs when the ink is applied to the substrate, by controlling the temperature of the work table 100 from part to part.

In operation S250, a temperature of at least one tile unit of the tile units 1200 may be individually controlled by controlling a current applied to a temperature control member 1230 the at least one tile unit 1200.

In an embodiment, a temperature of each tile unit 1200 of the tile units 1200 may be controlled using the temperature control members 1230 of the tile units 1200 to match a temperature of the ink deposited on the substrate. For example, a matching temperature may be within about 5 degrees C., or within about 1 degree C., or within about 0.5 degree C.

In this way, the inkjet printing apparatus 1 according to an embodiment of the present disclosure may prevent or reduce a problem of the temperature of the substrate changing due to the temperature of the ink even when the temperature of the ink is controlled to control the viscosity of the ink to be ejected.

Furthermore, the inkjet printing apparatus 1 according to an embodiment of the present disclosure may control in advance the temperature of the position where the ink droplet is to be dropped to control the properties of the ink droplet dropped onto the substrate.

In addition, the inkjet printing apparatus 1 according to an embodiment of the present disclosure may prevent or reduce the temperature change problem of the substrate that may occur when the nozzle unit 310 repeatedly drops the ink onto the substrate, thereby performing a high-precision inkjet process.

In addition, a method of manufacturing the inkjet printing apparatus 1 according to an embodiment of the present disclosure may provide the inkjet printing apparatus 1 having one or more of the technical effects described herein.

The inkjet printing apparatus and the method of manufacturing the inkjet printing apparatus according to an embodiment of the present disclosure may provide an inkjet printing apparatus capable of performing a high-precision inkjet process and a method of manufacturing the inkjet printing apparatus.

The present disclosure may provide an inkjet printing apparatus capable of performing a high-precision inkjet process and a method of manufacturing the same.

However, these effects are exemplary, and effects of the present disclosure are not limited thereto.

Embodiments described herein may be implemented independently, but the structure of each embodiment may be applied in combination to other embodiments.

Although the present disclosure has been described with reference to an example shown in the drawings, it will be understood by those of ordinary skill in the art that various modifications and equivalent other examples may be made from the shown example. Accordingly, the true technical scope of the present disclosure should be defined by the technical spirit of the appended claims.

Specific implementations described in connection with embodiments are examples and do not limit the scope of embodiments in any way. In addition, when there is no specific mentioning, such as “essential” or “important”, it may not be a necessary component for the application of the present disclosure.

In the specification (especially, claims) of the present disclosure, the use of the term “the” and similar indicators thereof may correspond to both the singular and the plural. Moreover, when a range is described in an example, the invention includes the application of individual values within the range (unless there is a statement to the contrary), and is the same as describing each individual value constituting the range in the detailed description. Finally, when there is no apparent description of the order of operations constituting the method according to the disclosure or a contrary description thereof, the operations may be performed in an appropriate order. However, embodiments are not necessarily limited according to the describing order of the operations. The use of all examples or exemplary terms in the present disclosure are to simply describe the disclosure in detail, and unless the range of the disclosure is not limited by the examples or the exemplary terms unless limited by the claims. In addition, it may be understood by those of ordinary skill in the art that various modifications, combinations, and changes may be made according to design conditions and factors within the scope of the appended claims or equivalents thereof.

What is claimed is:

1. An inkjet printing apparatus comprising:
a work table comprising a table body comprising a work region;
a plurality of tile units arranged on the work region;
a temperature control member disposed in at least one tile unit of the plurality of tile units;
an inkjet assembly arranged on the tile unit and comprising a nozzle unit configured to drop ink from above the plurality of tile units; and
a controller configured to individually control a temperature of the at least one tile unit by controlling current applied to the temperature control member.

2. The inkjet printing apparatus of claim 1, wherein the table body comprises a mount hole formed to extend in a direction, and
each tile unit of the plurality of tile units comprises an engagement portion at least partially inserted into the mount hole.

3. The inkjet printing apparatus of claim 1, wherein the plurality of tile units are arranged in a grid shape on the work region.

4. The inkjet printing apparatus of claim 1, wherein the at least one tile unit comprises:
a base plate on which the temperature control member is arranged; and
a top plate disposed opposite to the base plate.

5. The inkjet printing apparatus of claim 4, wherein the base plate comprises a cable hole, wherein a cable connected to the temperature control member is disposed to pass through the cable hole.

6. The inkjet printing apparatus of claim 4, wherein a plurality of temperature control members, including the temperature control member, disposed in the plurality of tile units are arranged spaced apart from each other on the base plate, and comprise a filler material disposed in a space between the plurality of temperature control members.

7. The inkjet printing apparatus of claim 4, wherein the base plate has a higher heat conductivity than the top plate.

8. The inkjet printing apparatus of claim 1, wherein the temperature control member comprises a Peltier element.

9. The inkjet printing apparatus of claim 1, wherein the controller is further configured to individually control the temperature of the at least one tile unit based on a position at which the nozzle unit drops ink.

10. A work table of an inkjet printing apparatus, the work table comprising:
a table body comprising a work region and comprising a plurality of through holes formed to extend in a direction;
a plurality of tile units disposed on the work region; and
a lift assembly comprising a plurality of pin modules disposed in the plurality of through holes.

11. The work table of claim 10, wherein the lift assembly further comprises a frame formed to be movable in a direction parallel to an extension direction of the plurality of through holes and connected to the plurality of pin modules.

12. The work table of claim 10, wherein the plurality of pin modules comprises:
a lift tube movable, linearly, in an extension direction of the plurality of through holes; and
a bushing disposed around a circumference of the lift tube.

13. The work table of claim 12, wherein each of the plurality of through holes comprises:
a body pin hole extending along a portion of a movement path of the lift tube; and
a counter bore connected to the body pin hole and accommodating the bushing.

14. The work table of claim 10, wherein each tile unit of the plurality of tile units comprises a curved portion formed to curve inward from each vertex of the tile unit, wherein a tile pin hole is formed by the curved portions of respective tile units of the plurality of tile units arranged adjacent to each other, and
wherein at least a part of a pin module of the plurality of pin modules is disposed in the tile pin hole.

15. The work table of claim 10, wherein each pin module of the plurality of pin modules comprises a pin tip arranged at an end portion disposed at a surface of each tile unit of the plurality of tile units.

16. The work table of claim 15, wherein the pin module is formed to be capable of securing a substrate supported on the pin tip by vacuum pressure.

17. A method of operating a work table of an inkjet printing apparatus, the method comprising:
preparing the work table comprising a table body, a lift assembly, and a plurality of tile units forming a surface of the work table;
moving the lift assembly such that at least a part of a pin module of the lift assembly passes through a body pin hole formed in the table body;
arranging a substrate on a pin tip of the pin module;
moving the lift assembly such that the substrate contacts the surface of the work table; and
securing the substrate to the work table by applying vacuum pressure to a surface of the substrate through the pin tip.

18. The method of claim 17, further comprising controlling, individually, a temperature of the at least one tile unit of the plurality of tile units by controlling a current applied to a temperature control member the at least one tile unit.

19. The method of claim 17, further comprising:
depositing an ink on the substrate; and
individually control a temperature of each tile unit of the plurality of tile units by controlling a plurality of temperature control members of the plurality of tile units to match a temperature of the ink deposited on the substrate.

20. The method of claim 17, wherein securing the substrate to the work table by applying vacuum pressure further comprises applying the vacuum pressure through a groove disposed in the pin tip to an air layer disposed between the plurality of tile units.
